(19) United States
(12) Patent Application Publication
(10) Pub. No.: US 2007/0118362 A1
(43) Pub. Date: May 24, 2007

(54) Audio compression/decompression device

(76) Inventor: Hiroaki Kondo, Osaka (JP)

Correspondence Address: MCDERMOTT WILL & EMERY LLP, 600 13TH STREET, NW, WASHINGTON, DC, 20005-3096, US

(21) Appl. No.: 10/582,962

(22) PCT Filed: Dec. 7, 2004
(86) PCT No.: PCT/JP04/18222

§ 371 Date: Jun. 15, 2006

(30) Foreign Application Priority Data
Dec. 15, 2003 (JP) 2003-416192

(51) Int. Cl. G10L 19/00

(52) U.S. Cl. 704/212

(57) ABSTRACT

An audio compression and decompression device of the present invention includes an LPF (102) which cuts off high frequency components existing at a high-frequency band of the digital audio data before compressed which are inputted to an ADPCM circuit (101) when the digital audio data are compressed or decompressed by the ADPCM method, thereby reducing quantization noises on the high-frequency band, occurring in the digital audio data after decompressed due to an increase of the compression ratio. The audio compression and decompression device further includes a controller (103) which can change characteristics of the LPF (102) according to a compression bit rate of the ADPCM circuit (101), thereby configuring the LPF so as to have optimum characteristics suited to the compression bit rate, and can reproduce the audio data in a sound quality that satisfies the user's preference.

### TECHNICAL FIELD

The present invention relates to an audio compression and decompression device which compresses audio data or decompresses compressed audio data and, more particularly, to an audio compression and decompression device which compresses audio data or decompresses compressed audio data by an Adaptive Differential Pulse Code Modulation (ADPCM) system.

### BACKGROUND ART

As typical audio signal modulation systems which are carried out in storing audio signals in forms which are closer to forms of original audio signals, there are a Pulse Code Modulation (PCM) system, a Delta Modulation (DM) system, a Differential Pulse Code Modulation (DPCM) system, and an ADPCM system.

The PCM system is a system in which audio waves are sampled for each certain period, the audio signal values at the respective sampling points are converted from analog into digital (A/D conversion), and the obtained digital values are expressed in code sequences comprising 0 and 1. The bit number required in digitizing the audio signal values are determined dependent on the degree as to how much high fidelity the original analog signal is to be recorded. As the bit number is increased more, minute changes of signals are recorded, the noises which occur based on the digital differences are reduced, and sounds which are close to the waveforms of actual sounds, thereby the sound quality is improved. However, as the bit number is increased, the audio data becomes large, which results in an increase in the memory capacity for recording the audio data. Therefore, in order to record a lot of audio data in a memory of a restricted memory capacity, the audio data is required to be efficiently compressed.

As a method to accomplish the same, there is a DM method in which with respect to information of audio signal of a sample, the data amount which is quantized and modulated is made one bit as a minimum. The DM system has a characteristic in that an audio signal is coded in such a manner that a signal at a certain timing and a signal at the next timing are compared, and it is judged whether the audio signal value at the present timing is higher or lower than the audio signal value at the next timing, and when it is higher, a code “1” is given while when it is lower, a code “0” is given. Therefore, it is only required for the memory to record one bit data for each sampling clock. Thereby, only a small memory capacity is required, and the audio data can be recorded for a long time. For example, while the system which modulates the audio data without compressing the same can only record audio data up to about 10 seconds due to the restriction in the memory, the DM system can record data up to about 100 seconds which is about ten times as that described above. However, the DM system invites deterioration of sound quality because the audio signal value (analog value) only changes by one step for one clock in the DM system.

That which is positioned intermediate between the DM system and the PCM system is a DPCM system. The DPCM system comprises replacing the one bit quantization in DM system by plural bits, and is characterized in that the remaining signal value between the audio signal value at a sampling clock and the audio signal value at the next sampling clock is directly stored. However, this DPCM system has drawbacks in that it is impossible to record the inclination with which the waveform of the audio signal is rising.

A system in which this problem is solved and an adaptive prediction is carried out by the DPCM system is called as an ADPCM system. This ADPCM system compares the audio signal value at a certain sampling timing and the audio signal value at the next sampling timing, and quantizes the difference between the inputted signal and the predicted signal in plural bits, thereby compressing the audio data.

Conventionally, an audio recording and reproduction device which compresses the audio data using the ADPCM system and records and reproduces the compressed data is proposed (Patent reference No.1). Hereinafter, the device disclosed in the patent reference No.1 is described with reference to 9. This audio recording/reproducing device converts the an analog audio signal which is obtained by cutting off the high-frequency band by a low-pass filter (LPF) 901 into a digital signal by an A/D converter circuit 902. Then, the digital signal is compressed by the ADPCM circuit 903 using the ADPCM method. The compressed audio data are recorded in a semiconductor memory 907. When the recorded audio data are to be reproduced, the compressed data are read from the semiconductor memory 907 and decompressed by the ADPCM circuit 903, and then, the decompressed data are converted into an analog signal by a D/A conversion circuit 904. Here, the ADPCM circuit 903 decompresses the compressed audio data by performing an inverse processing to the compression processing. Then, a high-frequency band of the analog signal which is outputted from the D/A conversion circuit 904 is cut off by an LPF 905, and the resulted analog signal is subject to a reproduction processing by a reproduction amplifier circuit 906. In FIG. 9, a control unit 908 controls a compression/decompression operation of the ADPCM circuit 903, recording of compressed data into the semiconductor memory 907 and reading out of compressed data from the semiconductor memory 907.
Patent Document 1: Japanese Unexamined Publication No.63-259700
Patent Document 2: Japanese Unexamined Publication No.6-85607

As described above, by employing the ADPCM system, it is possible to compress audio data with maintaining a high sound quality. However, the ADPCM system has a drawback that quantization noises are likely to occur at high frequency band since the distribution of power spectrum of quantization noises is not uniform in view of frequency. For example, comparing at the same sampling frequency, when the coding bit number is decreased by one bit, the frequency band of the noises become about a half. Therefore, when the coding bit number is reduced and up to exceeding a certain bit rate, the frequency band at which quantization noises occur enter the audible band of a human being (up to about 22 kHz). In this case, audible quantization noises mix into audio, resulting in harsh sounds. Accordingly, it can be concluded that the quantization noises are barely noticed when audio data are compressed with a low compression ratio, while noticeable quantization noises will occur especially at the high-frequency band when the compression ratio of audio data is too high.

In the audio recording/reproducing device shown in FIG. 9, though the high-frequency components are removed by the LPF 901 prior to performing an A/D conversion, this LPF only removes components which do not appear as data, or components which appear in waveforms which are different from those of the original sound, and therefore, it cannot reduce quantization noises at the high-frequency band which are generated in compressing the audio data by the ADPCM system. Further, since this audio recording/reproducing device compresses analog signals with taking in those into the same, it is impossible to perform a processing for the digital audio data which are recorded in a recording medium by such as a CD-DA (Compact Disk-Digital Audio) system.

The present invention has for its object to provide an audio compression and decompression device which can reduce quantization noises that occur at a high-frequency band in compressing or decompressing digital audio data by an ADPCM system.

### DISCLOSURE OF THE INVENTION

In order to solve the above-mentioned problems, according to the present invention, there is provided an audio compression and decompression device comprising: an adaptive differential pulse code modulation circuit which modulates digital audio data by an adaptive differential pulse code modulation system; a high frequency component cutting unit which cuts off high frequency components existing on a high-frequency band of the digital audio data before compression which are inputted to the adaptive differential pulse code modulation circuit, or the digital audio data after decompression which are outputted from the adaptive differential pulse code modulation circuit; and a controller which changes cutoff frequency characteristics of the high frequency component cutting unit according to a compression bit rate of the adaptive differential pulse code modulation circuit.

According to the present invention, there is provided an audio compression and decompression device comprising: an adaptive differential pulse code modulation circuit which modulates digital audio data by an adaptive differential pulse code modulation system; a high frequency component cutting unit which cuts off high frequency components existing on a high-frequency band of the digital audio data before compression which are inputted to the adaptive differential pulse code modulation circuit; and an amplitude detection circuit which detects an amplitude in a high frequency region of the digital audio data before compressed which are inputted to the adaptive differential pulse code modulation circuit; and a controller which compares the amplitude detected by the amplitude detection circuit with a threshold value, and changes the cutoff frequency characteristics of the high frequency component cutting unit on the basis of the comparison result.

According to the present invention, in the audio compression and decompression device the controller changes the cutoff frequency characteristics of the high frequency component cutting unit when the amplitude detected by the amplitude detection circuit exceeds the threshold value.

According to the present invention (Claims 12), in the audio compression and decompression device the controller changes the cutoff frequency characteristics of the high frequency component cutting unit when the amplitude detected by the amplitude detection circuit has exceeded the threshold value during a previously set time period, or when amplitude detected by the amplitude detection circuit has not exceeded the threshold value during a previously set time period.

Effects of the Invention

The audio compression and decompression device of the present invention comprises an adaptive differential pulse code modulation circuit which modulates digital audio data by an adaptive differential pulse code modulation system, a high frequency component cutting unit which cuts off high frequency components existing on a high-frequency band of the digital audio data before compression which are inputted to the adaptive differential pulse code modulation circuit, or the digital audio data after decompression which are outputted from the adaptive differential pulse code modulation circuit, and a controller which changes cutoff frequency characteristics of the high frequency component cutting unit according to a compression bit rate of the adaptive differential pulse code modulation circuit. Therefore, it is possible to change the cutoff frequency characteristics of the high frequency component cutting unit, to the most suitable characteristics in accordance with a compression bit rate of the adaptive differential pulse code modulation circuit, and consequently, it is possible to reproduce digital audio data in a sound quality that is suited to the user's preference.

The audio compression and decompression device of the present invention comprises an adaptive differential pulse code modulation circuit which modulates digital audio data by an adaptive differential pulse code modulation system, a high frequency component cutting unit which cuts off high frequency components existing on a high-frequency band of the digital audio data before compression which are inputted to the adaptive differential pulse code modulation circuit, and an amplitude detection circuit which detects an amplitude in a high frequency region of the digital audio data before compressed which are inputted to the adaptive differential pulse code modulation circuit; and a controller which compares the amplitude detected by the amplitude detection circuit with a threshold value, and changes the cutoff frequency characteristics of the high frequency component cutting unit on the basis of the comparison result. Therefore, it is possible to change the cut off frequency characteristics of the high frequency component cutting unit, according to the nature of the audio data. Consequently, it is possible to change the cutoff frequency characteristics of the high frequency component cutting unit to those suitable to the audio data, without requiring the user to change the cutoff frequency characteristics of the high frequency component cutting unit, or even for audio data which the user listens to for the first time.

According to the present invention, in the audio compression and decompression device, the controller changes the cutoff frequency characteristics of the high frequency component cutting unit when the amplitude detected by the amplitude detection circuit has exceeded the threshold value during a previously set time period, or when amplitude detected by the amplitude detection circuit has not exceeded the threshold value during a previously set time period.

Therefore, it is possible to change the cutoff frequency characteristics of the high frequency component cutting unit, corresponding to various types of audio data which have different lengths of the high frequency ranges.

### BRIEF DESCRIPTION OF THE DRAWINGS

FIG. 1 is a block diagram schematically showing an audio compression and decompression device according to a first embodiment of the present invention.

FIG. 2 is a block diagram schematically showing an audio compression and decompression device according to a second embodiment of the present invention.

FIG. 3 is a block diagram schematically showing an audio compression and decompression device according to a third embodiment of the present invention.

FIG. 4 is a block diagram schematically showing an audio compression and decompression device according to a fourth embodiment of the present invention.

FIG. 5 is a block diagram illustrating an LPF in an audio compression and decompression device according to a fifth embodiment of the present invention.

FIG. 6 is a block diagram schematically showing an audio compression and decompression device according to a sixth embodiment of the present invention.

FIG. 7 is a block diagram illustrating an LPF in the audio compression and decompression device according to the first embodiment.

FIG. 8 is a diagram showing the audio compression and decompression device of the present invention, which is applied for shockproof reproduction.

FIG. 9 is a block diagram schematically showing a conventional audio compression recording device.

### DESCRIPTION OF THE NUMERALS

101, 806, 903 . . . ADPCM circuit
102, 202, 805, 901, 905 . . . LPF
103 . . . controller
104 . . . noise addition circuit
105 . . . amplitude detection circuit
501a˜501c, 508a˜508c, 701, 812 . . . delay circuit
502a˜502c, 504, 506, 507a˜507c, 702, 704, 813, 815 . . . multiplier
503, 505, 703, 814 . . . adder
801 . . . CD
802 . . . pickup
803 . . . head amplifier
804 . . . digital signal processing circuit
808, 907 . . . semiconductor memory
809, 904 . . . D/A conversion circuit
810 . . . amplifier
811 . . . speaker
902 . . . A/D conversion circuit
908 . . . control unit

### BEST MODE FOR CARRYING OUT THE INVENTION

### Embodiment 1

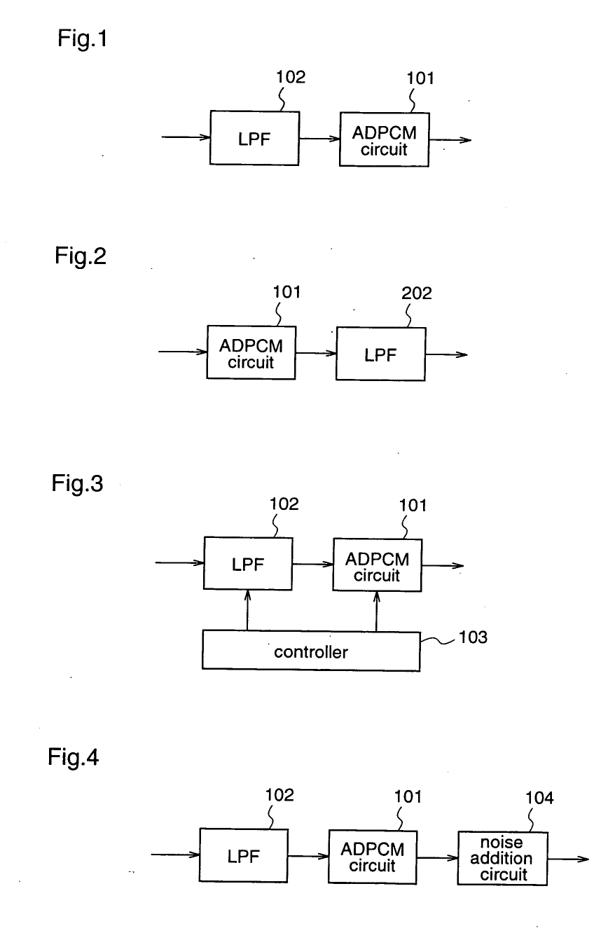

An audio compression and decompression device according to a first embodiment of the present invention will be described hereinafter with reference to FIG. 1. The audio compression and decompression device as shown in FIG. 1 includes an ADPCM circuit 101 and an LPF 102, and compresses or decompresses input digital audio data by the ADPCM system. The digital audio data to be inputted are, for example, digital audio data that are recorded on a recording medium by the CD-DA system.

In FIG. 1, the audio compression and decompression device includes a high frequency component cutting unit which cuts off high frequency components existing on a high-frequency band of the digital audio data before compressed which are inputted to the ADPCM circuit 101. The audio compression and decompression device according to the first embodiment has the LPF 102 as the high frequency component cutting unit, and directly cuts off the high frequency components by this LPF 102.

FIG. 7 shows a simple structural example of the LPF 102. In FIG. 7, the LPF 102 delays the input digital audio data by a delay circuit 701, the delayed data is multiplied with a multiplier coefficient α₁ by a multiplier 702, the input digital audio data and the output from the multiplier 702 are added by an adder 703, and the output from the adder 703 is multiplied with an inverse of a sum of the multiplier coefficient α₁ and 1 by a multiplier 704. Then, the output from the multiplier 704 is inputted to the ADPCM circuit 101.

The digital audio data from which the high frequency components existing on the high frequency band have been cut off in this way are compressed by the ADPCM circuit 101 according to the ADPCM system. As the compression and decompression processes by the ADPCM system have been described in the Background Art, their descriptions are omitted here.

As described above, the audio compression and decompression device according to the first embodiment cuts off high frequency components existing on the high frequency band of the digital audio data before compressed which are inputted to the ADPCM circuit 101 by the LPF 102. Therefore, when compressing the digital audio data according to the ADPCM system, it is possible to reduce quantization noises which are generated on the high frequency band of the digital audio data after decompressed due to that the compression ratio is increased.

Consequently, the audio compression and decompression device according to the first embodiment becomes useful for shockproof reproduction. The shockproof reproduction is a method in which, for example, provided for cases where a PCM signal which is recorded on a CD according to the CD-DA method is to be read out to reproduce the audio data, but the reading out was not successful due to some external factors, the audio data is compressed and stored in a semiconductor memory. Since the audio compression and decompression device according to the first embodiment can suppress quantization noises which occur on the high-frequency band even when the compression ratio of the audio data is increased, it is possible to increase the compression ratio of the audio data and effectively utilize the capacity of the semiconductor memory in the shockproof reproduction.

### Embodiment 2

An audio compression and decompression device according to a second Embodiment of the present invention will be described hereinafter with reference to FIG. 2. The audio compression and decompression device shown in FIG. 2 is different from the audio compression and decompression device shown in FIG. 1 in that an LPF 202 is provided as the high frequency component cutting unit, at a latter stage of the ADPCM circuit 101. That is, high frequency components existing on the high frequency band of the digital audio data after decompressed which are outputted from the ADPCM circuit 101 are directly cut off by the LPF 202.

As described above, the audio compression and decompression device according to the second embodiment directly cuts off high frequency components existing on the high frequency band of the digital audio data after decompressed which are outputted from the ADPCM circuit 101 by the LPF 202. Therefore, when compressing the digital audio data according to the ADPCM method, it is possible to reduce quantization noises which are generated on the high frequency band of the digital audio data after decompressed due to that the compression ratio is increased.

In this second embodiment, the LPF is provided at a latter stage of the ADPCM circuit as the high frequency component cutting unit. However, the present invention is not limited to this structure, and a noise shaper may be provided as the high frequency component cutting unit at a latter stage of the ADPCM circuit so that quantization noises which occur on the high-frequency band of the digital audio data after decompressed which are outputted from the ADPCM circuit are removed by this noise shaper. In this case, though the circuit structure itself becomes complicated due to that the structure of the noise shaper itself is complicated, it becomes possible to reproduce the digital audio data with a high sound quality because the quantization noises can be effectively removed.

### Embodiment 3

An audio compression and decompression device according to a third embodiment of the present invention will be described hereinafter with reference to FIG. 3. The audio compression and decompression device according to the third embodiment is characterized in further being provided with a controller 103 in the audio compression and decompression device as shown in FIG. 1. The controller 103 functions to change characteristics (cutoff frequency characteristics) of the LPF 102 according to a compression bit rate of the ADPCM circuit 101.

For example, when the number of bits of the compression bit rate of the ADPCM circuit 101 is increased to lower the compression ratio, quantization noises in the digital audio data after decompressed are not so noticeable, and by that the data are made pass through the LPF, the high frequency band may be excessively cut off, thereby deteriorating the sound quality. In such case, the controller 103 performs a control not to make the digital audio data pass through the LPF 102 or changes the characteristics of the LPF 102 to that having a gradual falling at the cut off. When the LPF 102 has the structure as shown in FIG. 7, the controller 103 can make the digital audio data not pass through the LPF 102 by setting the multiplier coefficient α₁ at 0. Further, the controller may perform a control so as to make the characteristics of the LPF 102 have a gradual falling at the cut off by changing the multiplier coefficient α₁. Here, “cutoff” means the frequency band from which the audio data are cut off, and “the falling at the cutoff” means a falling from the frequency band at which the audio data are cut off.

In contrast, when by that the bit number of the compression bit rate of the ADPCM circuit 101 is decreased to increase the compression ratio, noticeable quantization noises would occur on the high-frequency band of the digital audio data after decompressed, the characteristics of the LPF 102 is changed to that which has a steep falling at the cut off, thereby suppressing deteriorations in the sound quality at reproducing the audio data. When the LPF 102 has the structure as shown in FIG. 7, the controller 103 can make the characteristics of the LPF 102 have a steep falling at the cut off by changing the multiplier coefficient α₁.

Further, the controller 103 changes not only the characteristics of the LPF 102 but the compression bit rate of the ADPCM circuit 101. In order to change the compression bit rate of the ADPCM circuit, levels of tones for compressing the audio data are changed.

For example, when the digital audio data are represented by 16 bits (65536 kinds of data), and the compression bit rate is set at 4 bits (16 tones of data), the digital audio data are allocated to ±8 levels (16 kinds) of tones, while when the compression bit rate is set at 3 bits (8 tones of data), the digital audio data are allocated to ±4 levels (8 kinds) of tones. Then, when the value of audio is within a certain range, the data is allocated to, for example, the X-th tone. That is, the tone the data is allocated is determined based on the audio value. In this case, the data as references for determining the tones are previously set in accordance with the compression bit rate (for example, 4 bits, or 3 bits).

Further, the controller 103 may have a function of receiving an instruction from the user. Thereby, the user can change the characteristics of the LPF 102. By manually changing the characteristics of the LPF 102 in accordance with the preference of the user, audio data can be reproduced in a sound quality at the user's preference. Since the judgment as to whether the sound quality of reproduced audio data is good or bad all the user's preferences are reflected, it is effective to change the characteristics of the LPF 102 according to the user's preference. Further, it can be also constructed in a manner that the controller 103 change the characteristics of the LPF 102 as well as the compression bit rate of the ADPCM circuit 101 on the basis of the user's instruction. Thereby, the user can also manually change the time period of audio data to be stored in the memory. Since the both of the characteristics of the LPF 102 and the compression bit rate can be changed, whether an importance is to be placed on the sound quality or a larger amount of audio data are to be stored in a memory (for example, a semiconductor memory) can be selected by the user.

Further, it is also effective that the controller 103 automatically changes the characteristics of the LPF 102. For example, by providing the controller 103 with a function of storing preferred characteristics of the LPF 102, which is suited to audio data the user has once listened to and automatically selecting the characteristics of the LPF 102 from the next time, it is possible to improve the convenience. Similarly, it is also possible to provide the controller 103 with a function of storing a compression bit rate which the user has set and automatically selecting the compression bit rate from the next time.

As described above, the audio compression and decompression device according to the third embodiment includes the ADPCM circuit 101, the LPF 102 which cuts off high frequency components existing on the high frequency band of the digital audio data before compressed which are inputted to the ADPCM circuit 101, and the controller 103 which changes the characteristics of the LPF 102 according to the compression bit rate of the ADPCM circuit 101. Therefore, it is possible to select optimum characteristics of the LPF according to the compression bit rate of the ADPCM circuit 101, and consequently, it is possible to reproduce the audio data in a sound quality that is suited to the user's preference. Further, by constructing the controller 103 capable of changing also the compression bit rate of the ADPCM circuit 101, it is possible to change the time period of audio data to be stored in a memory, in accordance with the user's preference.

In this third embodiment, the descriptions are given of a case where the controller 103 is provided in the audio compression and decompression device as shown in FIG. 1. However, the present invention is not limited to this structure, and the controller 103 may be provided in the audio compression and decompression device as shown in FIG. 2.

### Embodiment 4

An audio compression and decompression device according to a fourth embodiment of the present invention will be described hereinafter with reference to FIG. 4. The audio compression and decompression device shown in FIG. 4 is characterized in that a noise addition circuit 104 is provided in the audio compression and decompression device as shown in FIG. 1. The noise addition circuit 104 functions to add noise components corresponding to high frequency components which have been cut by the LPF 102, to the digital audio data before decompressed which are outputted from the ADPCM circuit 101. More specifically, it adds noise components to the upper limit of the audible frequency band or the frequency band above the upper limit. Hereinafter, an example of the noise addition circuit 104 will be described (refer to Patent Document 2). A noise addition circuit described in Patent Document 2 carries out a frequency analysis of the original audio signal and extracts, from the analysis result, tone color components which include fundamental tones and harmonic overtones in combination in the original sound signal band. Then, using the extracted tone color components, the harmonic overtones at a higher tone band than the original audio signal band are predicted, and the predicted harmonic overtones are inserted into the original audio signal. The noise addition circuit 104 is not limited to this structure, and may have any structure which adds noise components to a frequency band of the upper limit of the audible frequency band or a higher frequency band than the upper limit.

Further, the audio compression and decompression device shown in FIG. 4 may further include the controller 103 as shown in FIG. 3, which may control the noise addition circuit 104 as well as the characteristics of the LPF 102, according to the compression bit rate of the ADPCM circuit 10l. More specifically, the controller controls noise components to be added, a frequency band to which the noises are added, volume of noises, and the like. Thereby, it is possible to change the noise components to be added, the frequency band to which the noises are added, the volume of noises, and the like to those which are optimum according to the compression bit rate, and reproduce the audio data in a higher sound quality.

Further, the controller may change the compression bit rate of the ADPCM circuit 101.

As described above, the audio compression and decompression device according to the fourth embodiment includes the noise addition circuit 104 which, when making the digital audio data before compressed which are inputted to the ADPCM circuit 101 pass through the LPF 102 to cut off high frequency components existing on a high frequency band, adds noises corresponding to high frequency components which are cut by the LPF 102 to the digital audio data after decompressed which are outputted from the ADPCM circuit 101. Thereby, it is possible to reproduce in a pseudo manner the high frequency components which are cut by the LPF 102. Consequently, it is possible to eliminate unnaturalness of the reproduced audio data due to the cutting of the high sound region, and thereby realizing reproduction of audio data that is comfortable to the human being.

### Embodiment 5

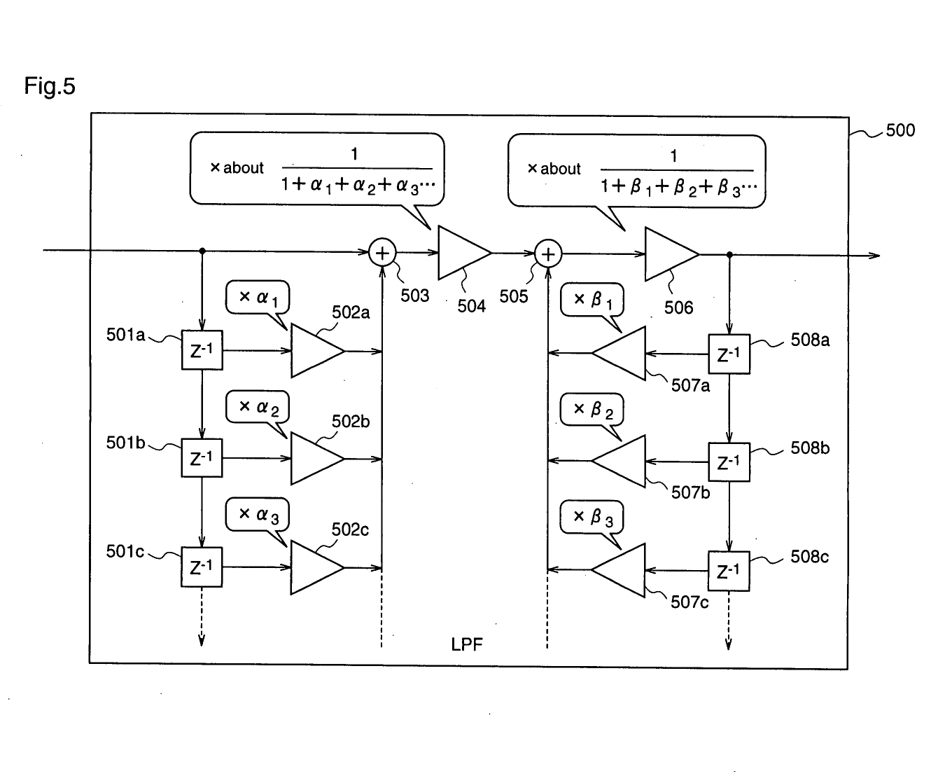

An audio compression and decompression device according to a fifth embodiment of the present invention will be described hereinafter with reference to FIG. 5. The audio compression and decompression device according to the fifth embodiment has such a construction that the LPF shown in any of FIGS. 1 to 4 cuts off the high sound components on the high frequency band using the input digital audio data and the output audio data of the past several samples. More specifically, as shown in FIG. 5, the LPF includes plural delay circuits and plural multipliers at the input side as well as plural delay circuits and plural multipliers at the output side.

Hereinafter, the operation of the LPF 500 as shown in FIG. 5 will be described. Initially, the plural first delay circuits (delay circuits 501a to 501c) at the input side operate to delay the input digital audio data of several samples. Then, plural first multipliers to multiply the respective outputs from the plural first delay circuits by previously set coefficients. That is, a multiplier 502a multiplies the output from the delay circuit 501a by a multiplication coefficient α₁, a multiplier 502b multiplies the output from the delay circuit 501b by a multiplication coefficient α₂, and a multiplier 502c multiplies the output from the delay circuit 501c by a multiplication coefficient α₃. Next, a first adder (adder 503) adds the outputs from the multipliers 502a to 502c and the input digital audio data. Then, a second multiplier (multiplier 504) multiplies the output from the adder 503 by an inverse of a sum of the total of the multiplication coefficients α₁ to α₃ and 1 (i.e., 1/1+α₁+α₂+α₃), as the previously set coefficient. The coefficient of the multiplier 504 is not needed to be an exact value of (1/1+α₁+α₂+α₃), and may be a value approximately equal to (1/1+α₁+α₂+α₃). Next, plural second delay circuits at the output side (delay circuits 508a to 508c) delay the output digital audio data by several samples. Then, plural third multipliers multiply respective outputs from the plural second delay circuits by previously set coefficients. That is, a multiplier 507a multiplies an output from the delay circuit 508a by a multiplication coefficient β₁, a multiplier 507b multiplies an output from the delay circuit 508b by a multiplication coefficient β₂, and a multiplier 507c multiplies an output from the delay circuit 508c by a multiplication coefficient β₃. Then, a second adder (adder 505) adds the outputs from the multipliers 507a to 507c and the output from the multiplier 504. Then, a fourth multiplier (multiplier 506) multiplies an output from the adder 505 by an inverse of a sum of the total of the multiplication coefficients β₁ to β₃ and 1 (i.e., 1/1+β₁+β₂+β₃), as a previously set coefficient. The coefficient of the multiplier 506 is not needed to be an exact value of (1/1+β₁+β₂+β₃), but may be a value approximately equal to (1/1+β₁+β₂β₃). Then, the output from the multiplier 506 is outputted to the outside as digital audio data from which high frequency components on the high-frequency band are removed.

In addition, it may also be possible to change the characteristics of the LPF 500 according to the compression bit rage of the ADPCM circuit 101 by using the controller. In this case, it is only required to change the multiplication coefficients α_{1,2,3} of the multipliers 501a to 501c and the multiplication coefficients β_{1,2,3} of the multipliers 507a to 507c, respectively.

As described above, the audio compression and decompression device according to the fifth embodiment transformed the structure of the LPF which cuts off the high sound region components existing on the high frequency band of the digital audio data before compressed by the ADPCM circuit 101 or the digital audio data after decompressed by the ADPCM circuit 101 to a structure of cutting off the high sound region components by using the input digital audio data and the output digital audio data of past several samples, and thereby, the characteristics of the LPF can be adjusted more finely.

In the fifth embodiment, the LPF 500 is provided with three delay circuits and three multipliers at the input side as well as at the output side, respectively, however, the numbers of the delay circuits and the multipliers are not limited thereto and may be plural numbers. Further, the delay circuits and the multipliers may be provided in plural only either of at the input side and at the output side.

### Embodiment 6

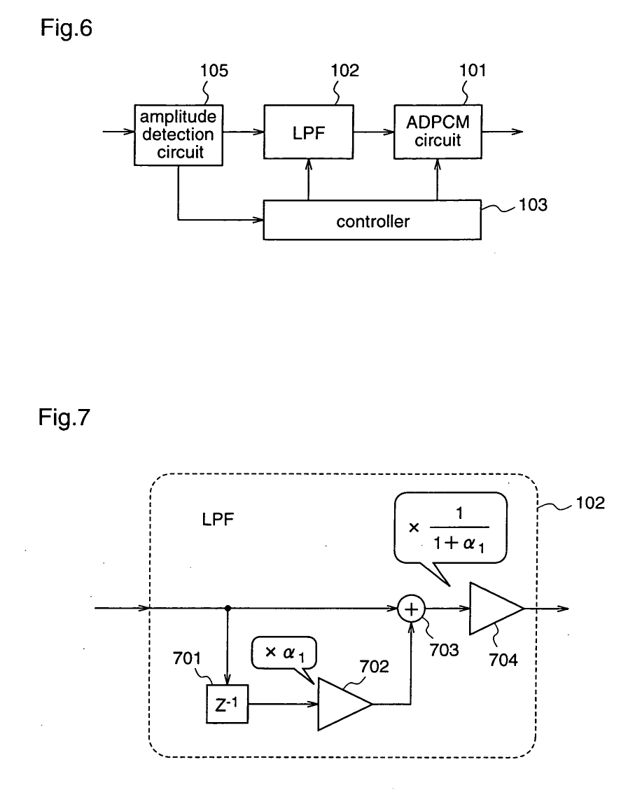

An audio compression and decompression device according to a sixth embodiment of the present invention will be described hereinafter with reference to FIG. 6. The audio compression and decompression device as shown in FIG. 6 is characterized in further including an amplitude detection circuit 105 in the audio compression and decompression device as shown in FIG. 3.

The amplitude detection circuit 105 detects the amplitude of a previously set frequency band in a high sound range of the digital audio data. The controller 103 changes the characteristics of the LPF 102 on the basis of the amplitude detected by the amplitude detection circuit 105. More specifically, the controller 103 changes the characteristics of the LPF 102 when the amplitude detected by the amplitude detection circuit 105 exceeds a previously set threshold value. Since it is supposed that quantization noises of the digital audio data after decompressed should increase when the amplitude increased, the characteristics of the LPF 102 is changed to that which has a steep falling at the cut off.

Since the length of the high sound range of the audio data varies with the type thereof, the controller 103 may automatically change the characteristics of the LPF 102 when the amplitude detected by the amplitude detection circuit 103 has exceeded the threshold value over a previously set time period (over several samples). In this case, the controller 103 changes the characteristics of the LPF 102 to that which has a steep falling at the cut off. In addition, it may change the characteristics of the LPF 102 when the amplitude detected by the amplitude detection circuit 105 does not exceed the threshold value over a previously set time period. In this case, the controller 103 changes the characteristics of the LPF 102 to that which has a gradual falling at the cut off.

As described above, the audio compression and decompression device according to the sixth embodiment includes the amplitude detection circuit 105 which detects the amplitude of a previously set frequency band in a high sound range of digital audio data, and the controller 103 changes the characteristics of the LPF 102 which cuts off the high-frequency band of the digital audio data on the basis of the detected amplitude. Thereby, it becomes unnecessary for the user to change the characteristics of the LPF 102 in each case, depending on the difference of the audio data. Further, with respect to the audio data which the user listens to for the first time, it is possible to set the characteristics of the LPF 102 that is optimum to the characteristics of the audio data.

### EXAMPLE 1

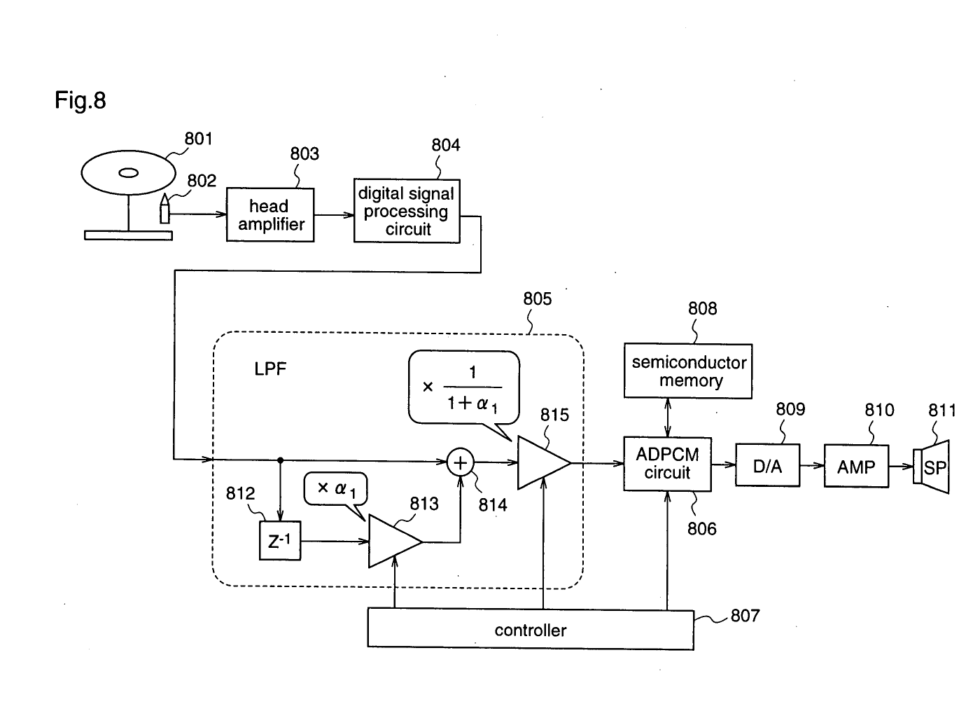

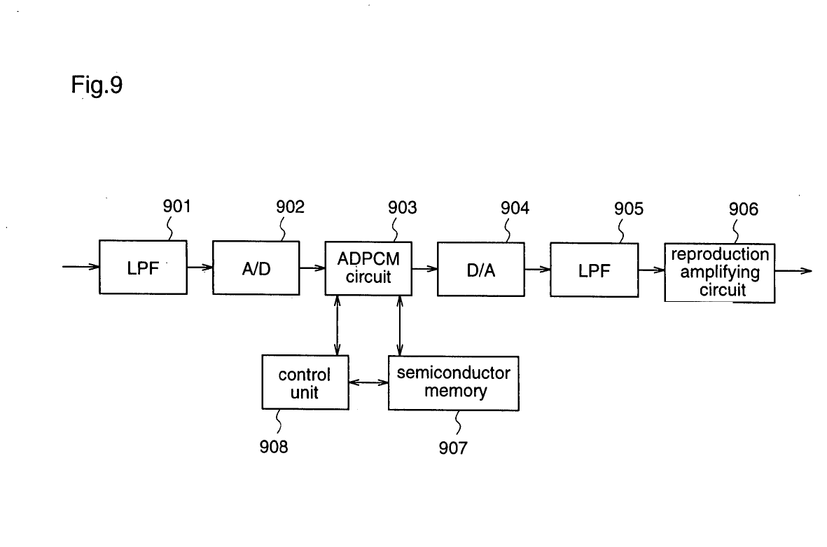

Hereinafter, an example of the audio compression and decompression device according to the present invention will be described with reference to FIG. 8. In this example, a case where the audio compression and decompression device of the present invention is applied to shockproof reproduction is described.

The reproduction device as shown in FIG. 8 amplifies an RF signal which was read out from a CD 801 by a pickup 802 using a head amplifier 803 and the RF signal is demodulated into a PCM signal of 16 bits at the sampling frequency of 44.1 kHz by a digital signal processing circuit 804. After this signal is made pass through an LPF 805, this signal is compressed by an ADPCM circuit 806, i.e., the PCM signal of 16 bits is compressed into compressed audio data of 4 bits or 3 bits, and it is recorded into a semiconductor memory 808. Simultaneously, reproduction is performed, i.e., the compressed audio data which was recorded in the semiconductor memory 808 is decompressed by the ADPCM circuit 806, and then converted into an analog signal by a D/A converter circuit 809, and this analog signal is amplified by an amplifier (AMP) 810 to be reproduced by a speaker (SP) 811. With this structure, even when audio data from a CD cannot be obtained for some reasons, for example, when the pickup which is reading data from the CD is deviated due to external vibrations, it is possible to continue reproduction by utilizing compressed audio data stored in the semiconductor memory 808, to remove meanwhile the causes preventing the reading out of audio data from the CD, and thereby to bring back into the original state thus without interrupting the reproduction. When a DRAM (Dynamic RAM) of 16 Mbits is practically employed as the semiconductor memory, it is possible to record audio data for about 45 seconds when the compression into 4 bits is performed while record audio data for about 60 seconds when the compression into 3 bits is performed by the ADPCM circuit 806.

As a method of recording audio data in a semiconductor memory for a long time, there is considered a method of increasing the capacity of the semiconductor memory, or a method of increasing the compression ratio of audio data. However, the increase in the memory capacity leads to an increase in cost or an increase in the device size, while the excessive increase in the compression ratio results in an increase in the quantization noises at the high-frequency band of the audio data. Practically, when a PCM signal of 16 bits which was demodulated by the digital signal processing circuit 804 was directly inputted to the ADPCM circuit 806 without passing through the LPF 805 and the compression is carried out into 3 bits, it is found that audible quantization noises at the high-frequency band were adversely noticeable when the decompressed audio data was reproduced.

At this point, in this example, in order to reduce these audible quantization noises, the PCM signal before compressed which is inputted to the ADPCM circuit 806 is made pass through the LPF 805 to cut off high frequency components existing at the high frequency band. Here, since the operation of the LPF 805 is the same as that of the LPF as shown in FIG. 7, the descriptions are omitted here. The structure of the LPF 805 may be similar to that of the LPF 500.

It is assumed here that the compression bit rate of the ADPCM circuit 806 is 3 bits, and quantization noises occurred when the PCM signal is compressed into 3 bits. In this case, the controller 807 sets an optimum multiplication coefficient α₁ which can reduce the quantization noises with this compression bit rate to the multiplier 813 in the LPF 805. For example, when the value of the multiplication coefficient α₁ is set at 1, an intermediate value between an input PCM signal and a PCM signal which has been inputted one sampling clock prior is taken, and thereby the high frequency components existing at the high-frequency band of the PCM signal are cut off. While it is assumed that α₁=1 in this example, the value of α₁ may be any value other than 1. The multiplication coefficient α₁ may not be an integer number.

On the other hand, when the audio data is to be reproduced in a high sound quality with lowering the compression ratio, there may be a case where the audible quantization noises are not so noticeable, even when the PCM signal is directly inputted to the ADPCM circuit 806 without passing through the LPF 805. However, if PCM signal is made pass through the LPF 805 in this case, high frequency components existing at the high-frequency band are excessively cut from the PCM signal, and the sound quality of audio data at the reproduction is adversely deteriorated. For example, when the multiplier coefficient α₁ of the LPF 805 is set as above in accordance with the compression bit rate of 3 bits, the sound quality of audio data at the reproduction will be deteriorated when the compression bit rate of the ADPCM circuit 806 is set to 4 bits. Accordingly, when there is no need to make the PCM signal pass through the LPF 805 by having lowered the compression ratio, the controller 807 should set the value of α₁ at 0, and carry out the compression of the original PCM signal as it is by the ADPCM circuit 806. Also, the value of the multiplication coefficient a α₁ may be changed thereby to change the characteristics of the LPF 805 to that which has a gradual falling at the cut off.

While in the above example the descriptions are given of a case where the PCM signal before compressed which is inputted to the ADPCM circuit 806 is made pass through the LPF 805, there may be provided the LPF 805 at a latter stage of the ADPCM circuit 806 and the audio data which is outputted from the ADPCM circuit 806 is made pass through the LPF 805.

### INDUSTRIAL AVAILABILITY

The present invention is suitable for devices and methods which compress digital audio data by the ADPCM system and reproduce the compressed data while simultaneously recording (for example, shockproof reproduction). Further, this is useful for a case where digital audio data are stored in a memory as well as for a case where digital audio data are transmitted with being compressed.

1-4. (canceled)

5. An audio compression and decompression device comprising:
an adaptive differential pulse code modulation circuit which modulates digital audio data by an adaptive differential pulse code modulation system;
a high frequency component cutting unit which cuts off high frequency components existing on a high frequency band of the digital audio data before compression which are inputted to the adaptive differential pulse code modulation circuit, or the digital audio data after decompressed which are outputted from the adaptive differential pulse code modulation circuit; and
a controller which changes cutoff frequency characteristics of the high frequency component cutting unit according to a compression bit rate of the adaptive differential pulse code modulation circuit.

6-9. (canceled)

10. An audio compression and decompression device comprising:
an adaptive differential pulse code modulation circuit which modulates digital audio data by an adaptive differential pulse code modulation system;
a high frequency component cutting unit which cuts off high frequency components existing on a high frequency band of the digital audio data before compression which are inputted to the adaptive differential pulse code modulation circuit;
an amplitude detection circuit which detects an amplitude in a high frequency region of the digital audio data before compressed which are inputted to the adaptive differential pulse code modulation circuit; and
a controller which compares the amplitude detected by the amplitude detection circuit with a threshold value, and changes the cutoff frequency characteristics of the high frequency component cutting unit on the basis of the comparison result.

11. The audio compression and decompression device as defined in claim 10 wherein
the controller changes the cutoff frequency characteristics of the high frequency component cutting unit when the amplitude detected by the amplitude detection circuit exceeds the threshold value.

12. The audio compression and decompression device as defined in claim 10 wherein
the controller changes the cutoff frequency characteristics of the high frequency component cutting unit when the amplitude detected by the amplitude detection circuit has exceeded the threshold value during a previously set time period, or when amplitude detected by the amplitude detection circuit has not exceeded the threshold value during a previously set time period.
